(19) United States
(12) Patent Application Publication
(10) Pub. No.: US 2026/0111600 A1
(43) Pub. Date: Apr. 23, 2026

(54) SYSTEMS AND METHODS FOR PROCESSING INPUT DATA COMPRISING A PLURALITY OF ELEMENTS TO TRANSFORM THE INPUT DATA INTO A PROTECTED DATASET FOR SECURED PROCESSING

(71) Applicant: AML JV, LLC, Aurora, CO (US)

(72) Inventors: Justin DALE, Aurora, CO (US); Frank MARKSON, Aurora, CO (US); Brett STEVENS, Aurora, CO (US); Austin GILLEN, Aurora, CO (US); Md Nazmul ISLAM, Aurora, CO (US)

(73) Assignee: AML JV, LLC, Aurora, CO (US)

(21) Appl. No.: 19/364,564

(22) Filed: Oct. 21, 2025

Related U.S. Application Data
(60) Provisional application No. 63/710,553, filed on Oct. 22, 2024.

(51) Int. Cl. G06F 21/62

(52) U.S. Cl. CPC G06F 21/6245

(57) ABSTRACT

Described herein are systems and methods that related to techniques for managing individual data (such as patient data). In examples, systems can be configured to obtain data associated with individual profiles; obtain data associated with individual samples indexed in accordance with a period of time; and for each individual, link one or more entries of the individual profile corresponding to the individual with individual samples corresponding to the individual based on the period of time and the profile for each individual. In some examples, the system can generate workflow profiles corresponding to each individual of the plurality of individuals based on linking the one or more entries of the individual profile with individual samples. The system can then de-identify the workflow profiles corresponding to each individual of the plurality of individuals to generate limited workflow profiles that are used to test one or more models in a development environment.

### CROSS-REFERENCE TO RELATED APPLICATION

The present application claims the benefit of, and priority to, U.S. Provisional Ser. No. 63/710,553 , filed Oct. 22, 2024, the entire contents of which are hereby incorporated by reference in their entirety for all purposes.

### TECHNICAL FIELD

This application generally relates to techniques for processing input data comprising a plurality of elements to transform the input data into a protected dataset for secured processing and, in some embodiments, to techniques for managing and updating individual data to be used to extract patterns represented by the data over periods of time.

### BACKGROUND

Currently, conditions such as acute myeloid leukemia (AML) are treated in coordination with profiles developed by clinicians and based on standard of care therapies. These profiles can include the use of targeted therapies such as administration of drugs targeting specific molecules or pathways involved in the growth and survival of the condition, stem cell transplants, and/or the like. Typically, these treatments are administered in conjunction with monitoring of the response of the individual through diagnostic testing and updated to optimize an individual's outcome. But it is often difficult for clinicians to determine which therapy will be most effective in treating the targeted condition. This can lead to therapies being applied to individuals that are less efficient and that do not result in an optimal outcome.

### SUMMARY

Embodiments described herein include systems and methods for managing individual data and can provide any number of additional or alternative benefits as well. When implemented, these systems and methods can address inefficiencies involved in conventional profiling. For example, the systems and methods described herein can allow for the refinement of individual data for downstream analysis. These datasets can be curated such that the datasets reflect profiles of a plurality of individuals and include information about the individuals'conditions, treatments, and outcomes. And once curated, the datasets can be used to train one or more machine learning (ML) models to both identify whether or not an individual has a given condition (as represented in association with one or more indirect markers and/or the like) and whether certain therapies are likely to be effective if implemented as part of the individual's profile. Further, the datasets as described herein can be curated to protect individual privacy while maintaining critical information needed to identify treatment alternatives available to the individual. For example, by offsetting time stamps associated with the limited workflow profiles as described herein and/or associating the limited workflow profiles with pseudo-identifiers, researchers can gain the benefit of larger volumes of data where entries that are clinically relevant would traditionally be altered, obscure, or removed entirely (e.g., attributes, geographic location, and/or the like) to protect individual privacy. This can, in turn, enable wider deployment of refined datasets including these limited workflow profiles for use in operations performed by data discovery engines and/or the like, as described herein.

In an embodiment, a system can include one or more processors configured to obtain data associated with individual profiles, each individual profile corresponding to an individual of a plurality of individuals and comprising at least one entry indexed in accordance with a period of time; obtain data associated with individual samples collected based on profiles associated with each individual of the plurality of individuals and indexed in accordance with the period of time. In examples, for each individual of the plurality of individuals, the one or more processors can link one or more entries of the individual profile corresponding to the individual with individual samples corresponding to the individual based on the period of time and the profile for each individual.

In some examples, the one or more processors can be configured to generate workflow profiles corresponding to each individual of the plurality of individuals based on linking the one or more entries of the individual profile with individual samples, each workflow profile comprising an individual identifier. The one or more processors can be configured to de-identify the workflow profiles corresponding to each individual of the plurality of individuals to generate limited workflow profiles, each limited treatment comprising a pseudo-identifier linked to the individual identifier; and store data associated with the limited workflow profiles in association with the pseudo-identifier in a storage device, the storage device allowing access to the data associated with the limited workflow profiles by one or more remote devices.

In some examples, the one or more processors configured to obtain the data associated with the individual profiles can be configured to: obtain the data associated with the individual profiles where each entry of the at least one entry comprises a time stamp based on the period of time and represents one or more of: individual attributes; a date of diagnosis for a condition; a subtype of the condition; blood test results; bone marrow biopsy results; cytogenic analysis results; molecular analysis results; treatment administration; or individual responses to treatment administration.

In some examples, the one or more processors configured to obtain the data associated with the individual samples can be configured to, for each individual of the plurality of individuals: obtain data associated with flow cytometry results generated based on a sample collected from the individual; or obtain data associated with droplet digital polymerase chain reaction (ddPCR) results generated based on a sample collected from the individual. In some examples, the one or more processors configured to generate the workflow profiles corresponding to each individual of the plurality of individuals can be configured to: transform one or more entries of the workflow profiles to normalize the one or more entries.

In some examples, the one or more processors configured to transform the one or more entries can be configured to transform the one or more entries based on one or more features associated with one or more models executed by the one or more remote devices. The one or more processors can be further configured to, for one or more individuals: obtain data associated with model outputs from the one or more remote devices, the model outputs comprising data associated with an update to one or more entries of the limited workflow profile of the individual. In some examples, in response to obtaining the data associated with the model outputs: the one or more processors can be configured to update the workflow profile of the individual to include the data associated with the update to the one or more entries of the limited workflow profile of the individual, or update the limited workflow profile of the individual to include the data associated with the update to the one or more entries of the limited workflow profile of the individual.

The one or more processors can be further configured to, for one or more individuals: obtain data associated with model outputs from the one or more remote devices, the model outputs comprising data associated with a new entry to the one or more entries of the limited workflow profile of the individual. In some examples, in response to obtaining the data associated with the model outputs, the one or more processors can be configured to add the data associated with the new entry to the one or more entries of the workflow profile of the individual, or add the data associated with the new entry to the one or more entries of the limited workflow profile of the individual.

In some examples, the one or more processors configured to de-identify the workflow profiles to generate limited workflow profiles can be configured to: determine an updated period of time based on the period of time and an offset value; and for each individual of the plurality of individuals: update a time stamp for each entry of the workflow profiles based on the updated period of time such that each time stamp is matched with a second time stamp, the second time stamp offset from the time stamp by the offset value.

In another embodiment, a method can comprise obtaining, by at least one processor, data associated with individual profiles, each individual profile corresponding to an individual of a plurality of individuals and comprising at least one entry indexed in accordance with a period of time; obtaining, by the at least one processor, data associated with individual samples collected based on profiles associated with each individual of the plurality of individuals and indexed in accordance with the period of time; for each individual of the plurality of individuals, linking, by the at least one processor, one or more entries of the individual profile corresponding to the individual with individual samples corresponding to the individual based on the period of time and the profile for each individual. In some examples, the method can comprise generating, by the at least one processor, workflow profiles corresponding to each individual of the plurality of individuals based on linking the one or more entries of the individual profile with individual samples, each workflow profile comprising an individual identifier; de-identify, by the at least one processor, the workflow profiles corresponding to each individual of the plurality of individuals to generate limited workflow profiles, each limited treatment comprising a pseudo-identifier linked to the individual identifier; and storing, by the at least one processor, data associated with the limited workflow profiles in association with the pseudo-identifier in a storage device, the storage device allowing access to the data associated with the limited workflow profiles by one or more remote devices.

In some examples, obtaining the data associated with the individual profiles can comprise obtaining, by the at least one processor, the data associated with the individual profiles where each entry of the at least one entry comprises a time stamp based on the period of time and represents one or more of: individual attributes; a date of diagnosis for a condition; a subtype of the condition; blood test results; bone marrow biopsy results; cytogenic analysis results; molecular analysis results; treatment administration; or individual responses to treatment administration. Obtaining the data associated with the individual samples can comprise, for each individual of the plurality of individuals: obtaining, by the at least one processor, data associated with flow cytometry results generated based on a sample collected from the individual; or obtaining, by the at least one processor, data associated with droplet digital polymerase chain reaction (ddPCR) results generated based on a sample collected from the individual.

In some examples, generating the treatments profiles corresponding to each individual of the plurality of individuals can comprise transforming, by the at least one processor, one or more entries of the workflow profiles to normalize the one or more entries. Transforming the one or more entries can comprise transforming, by the at least one processor, the one or more entries based on one or more features associated with one or more models executed by the one or more remote devices.

In some examples, the method can further comprise, for one or more individuals: obtaining, by the at least one processor, data associated with model outputs from the one or more remote devices, the model outputs comprising data associated with an update to one or more entries of the limited workflow profile of the individual; and in response to obtaining the data associated with the model outputs: updating, by the at least one processor, the workflow profile of the individual to include the data associated with the update to the one or more entries of the limited workflow profile of the individual, or updating, by the at least one processor, the limited workflow profile of the individual to include the data associated with the update to the one or more entries of the limited workflow profile of the individual.

In some examples, the method can further comprise, for one or more individuals: obtaining, by the at least one processor, data associated with model outputs from the one or more remote devices, the model outputs comprising data associated with a new entry to the one or more entries of the limited workflow profile of the individual; and in response to obtaining the data associated with the model outputs: adding, by the at least one processor, the data associated with the new entry to the one or more entries of the workflow profile of the individual, or adding, by the at least one processor, the data associated with the new entry to the one or more entries of the limited workflow profile of the individual.

In some examples, de-identifying the workflow profiles to generate limited workflow profiles can comprise determining, by the at least one processor, an updated period of time based on the period of time and an offset value; and for each individual of the plurality of individuals: updating, by the at least one processor, a time stamp for each entry of the workflow profiles based on the updated period of time such that each time stamp is matched with a second time stamp, the second time stamp offset from the time stamp by the offset value.

In yet another embodiment, a non-transitory, computer-readable medium having instructions stored thereon that, when executed by one or more processors, cause the one or more processors to: obtain data associated with individual profiles, each individual profile corresponding to an individual of a plurality of individuals and comprising at least one entry indexed in accordance with a period of time; obtain data associated with individual samples collected based on profiles associated with each individual of the plurality of individuals and indexed in accordance with the period of time; for each individual of the plurality of individuals, link one or more entries of the individual profile corresponding to the individual with individual samples corresponding to the individual based on the period of time and the profile for each individual. In some examples, the one or more processors can generate workflow profiles corresponding to each individual of the plurality of individuals based on linking the one or more entries of the individual profile with individual samples, each workflow profile comprising an individual identifier; de-identify the workflow profiles corresponding to each individual of the plurality of individuals to generate limited workflow profiles, each limited treatment comprising a pseudo-identifier linked to the individual identifier; and store data associated with the limited workflow profiles in association with the pseudo-identifier in a storage device, the storage device allowing access to the data associated with the limited workflow profiles by one or more remote devices.

In some examples, the instructions that can cause the one or more processors to obtain the data associated with the individual profiles can cause the one or more processors to: obtain the data associated with the individual profiles where each entry of the at least one entry comprises a time stamp based on the period of time and represents one or more of: individual attributes; a date of diagnosis for a condition; a subtype of the condition; blood test results; bone marrow biopsy results; cytogenic analysis results; molecular analysis results; treatment administration; or individual responses to treatment administration.

In some examples, the instructions that can cause the one or more processors to obtain the data associated with the individual samples can cause the one or more processors to: for each individual of the plurality of individuals: obtain data associated with flow cytometry results generated based on a sample collected from the individual; or obtain data associated with droplet digital polymerase chain reaction (ddPCR) results generated based on a sample collected from the individual. In some examples, the instructions that can cause the one or more processors to generate the workflow profiles corresponding to each individual of the plurality of individuals can cause the one or more processors to: transform one or more entries of the workflow profiles to normalize the one or more entries.

By virtue of the implementation of the techniques described herein, the systems and methods described allow for determination of a profile (or aspects thereof) for an individual that is highly individualized. Conventional processes for profiling involve applying a treatment typically used for treating the given condition (e.g., chemotherapy) in accordance with generally accepted standards of care, but often do not take into account the specific characteristics of the individual profile, which can lead to adverse side effects if the applied treatment is not suitable for the individual. Such determination of a profile using the systems and methods described herein, allows for more effective, predictable, and safe treatment outcomes by using the one or more trained ML models to refine the profile to the specific characteristics of the individual.

It is to be understood that both the foregoing general description and the following detailed description are exemplary and explanatory, and are intended to provide further explanation of the embodiments described herein.

### BRIEF DESCRIPTION OF THE DRAWINGS

The accompanying drawings constitute a part of this specification, illustrate one or more embodiments and, together with the specification, explain the subject matter of the disclosure.

FIG. 1 is a block diagram of an environment, in accordance with one or more embodiments described herein.

FIG. 2 is a flow diagram illustrating operations of a method for managing individual data, in accordance with one or more embodiments described herein.

FIG. 3A-3F are a diagram of an example implementation of the method of FIG. 2, in accordance with one or more embodiments described herein.

### DETAILED DESCRIPTION

Reference will now be made to the embodiments illustrated in the drawings, and specific language will be used here to describe the same. It will nevertheless be understood that no limitation of the scope of the disclosure is thereby intended. Alterations and further modifications of the features illustrated here, and additional applications of the principles as illustrated here, which would occur to a person skilled in the relevant art and having possession of this disclosure, are to be considered within the scope of the disclosure.

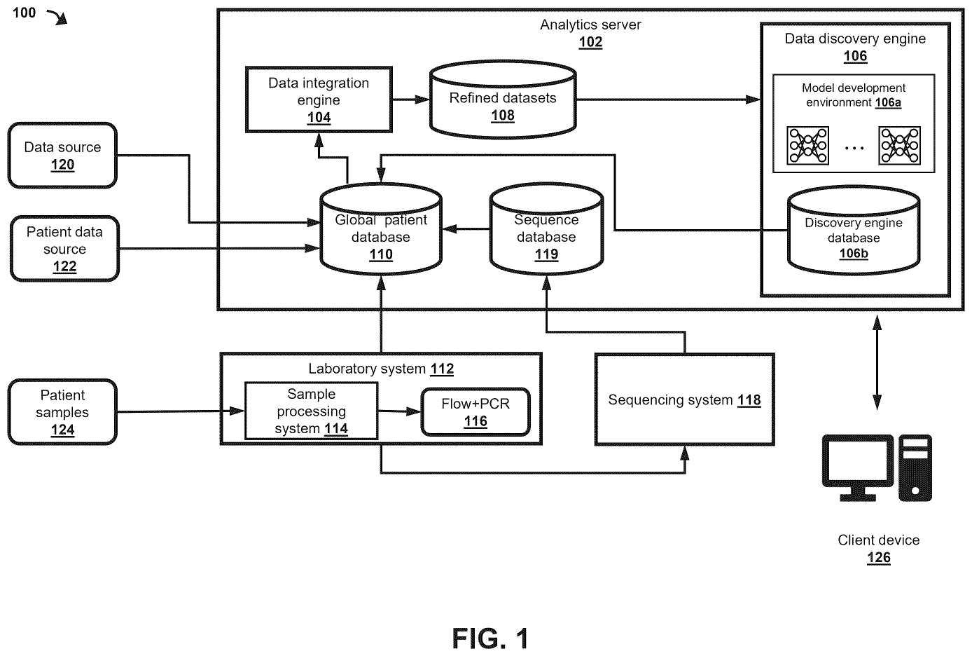

FIG. 1 is a block diagram of an environment 100 for managing individual data (also referred to as patient data herein), according to an embodiment. The environment 100 can include an analytics server 102, a laboratory system 112, a sequencing system 118, a data source 120, patient data source 122, patient samples 124, and a client device 126. Various components depicted in FIG. 1 can belong to an organization involved in clinical research of one or more conditions (e.g., diseases) such as, for example, acute myeloid leukemia (AML) or other diseases and/or to one or more organizations involved in treating patients with the one or more diseases. While certain components and devices are illustrated as being included in the environment 100 of FIG. 1, it will be understood that the environment 100 is not confined to the components or diseases as described herein and can include additional or different components (not shown for purposes of brevity and clarity) which are configured to be considered within the scope of the embodiments described herein.

In some embodiments, the analytics server 102 can include any computing device comprising a processor and non-transitory machine-readable storage capable of executing the various tasks, processes, and/or operations as described herein. The analytics server 102 can employ various processors such as central processing units (CPUs), graphical processing units (GPUs), and/or the like. Some non-limiting examples of such computing devices can include workstation computers, laptop computers, server computers, and/or the like. While the environment 100 includes a single analytics server 102, there can be multiple analytics servers 102. Further, the analytics server 102 can include any number of computing devices operating in a distributed computing environment such as, for example, a cloud computing environment. As described herein, the analytics server 102 can include a data integration engine 104, a data discovery engine 106, refined datasets 108, a global patient database 110, and a sequence database 119. In some embodiments, the analytics server 102 can include and/or implement operations that are associated with the laboratory system 112, the sequencing system 118, and/or the client device 126. In some embodiments, the analytics server 102 can include and/or implement operations that are associated with (e.g., involved in the generation of) the data source 120, the patient data source 122, and/or the patient samples 124.

In some embodiments, the analytics server 102 can be configured to receive data from the data source 120, the patient data source 122, and the laboratory system 112 and sequencing system 118 when processing patient samples 124. For example, the analytics server 102 can be configured to receive data from the data source 120, where the data is associated with (e.g., represents) entries corresponding to one or more patient files. As an example, as patients interact with clinicians, the clinicians can generate information that are received as input at a client device (not explicitly illustrated) that is associated with the clinicians, the notes indicating clinical observations and/or updates to profiles for the patients made by the clinician. The client device can then generate patient data that is associated with each patient and representative of the clinical observations or updates to the profiles and store the patient data in the data source 120 to later transmit to the analytics server 102. In this example, the analytics server 102 can implement the global patient database 110 such that the patient data is uploaded and stored in the global patient database 110 in association with one or more identifiers for the patient as described herein.

In another example, the analytics server 102 can be configured to receive data from the patient data source 122, where the data is associated with (e.g., represents) information about individual patients. As an example, as a history of a patient is obtained, the clinicians and/or the patients can generate information that is received as input at a client device (not explicitly illustrated) that is associated with the clinicians and/or patients, the information indicating aspects of the history of the patient such as whether the patient is associated with a history of a given disease in their family, whether the patient had any exposure to environmental conditions associated with the given disease, and/or the like. The client device can then generate patient data that is associated with each patient and representative of the history of the patient and store the patient data in the patient data source 122 to later transmit to the analytics server 102. In this example, the analytics server 102 can obtain and store the patient data in the global patient database 110 in association with one or more identifiers for the patient as described herein.

In yet another example, the analytics server 102 can be configured to receive data from the laboratory system 112 and/or the sequencing system 118, where the data is associated with (e.g., represents) information about patient samples (e.g., tissue samples, blood samples, blood counts (e.g., complete blood counts), bone marrow aspiration and biopsy results, lumbar puncture results, and/or the like) as well as the results of the processing of the samples (e.g., a DNA sequence or targets thereof). As an example, as a patient is evaluated and/or treated for a disease such as AML, patient samples 124 similar to those described above can be obtained. The patient samples 124 can be initially obtained and processed by a laboratory system 112 and processed by a sample processing system 114. The sample processing system 114 can implement one or more devices configured to obtain and store the patient samples and extract DNA from the patient samples. For example, in preparation for genetic analysis to guide AML treatment, patient blood or bone marrow can first be obtained from a patient and frozen. Later, these samples can be quality checked to ensure the sample purity and quantity are sufficient for sequencing. In some embodiments, the isolated DNA can then undergo further processing to be separated into manageable fragments and equipped with adapters (e.g., short, specific pieces of synthetic DNA associated with the fragmented DNA molecules) for compatibility with sequencing machines. In some embodiments, the samples can also be provided to a flow and polymerase chain reaction (PCR) system to extract and amplify the isolated DNA. The laboratory system 112 can then provide the processed samples and corresponding data representing the samples to be processed by the sequencing system 118. Additionally, or alternatively, the laboratory system 112 can then provide the data generated by the laboratory system 112 when processing the samples to the analytics server 102 to be stored in the global patient database 110.

In some embodiments, the sequencing system 118 can be configured to receive the patient samples and/or the isolated DNA and sequence the patient samples. In one example, the sequencing system 118 can attach DNA fragments to a surface in a specific pattern, creating clusters. The sequencing itself can involve a series of cycles where fluorescently labeled nucleotides are introduced one by one. The incorporation of each base can be detected, identifying the sequence of the fragment base by base. Finally, the sequencing system 118 can analyze the vast amount of data, assemble the original DNA sequences and identify any variations or mutations present (sometimes referred to as Next-Generation Sequencing (NGS)). The sequencing system 118 can then provide data associated with the sequenced DNA to the analytics server 102. In this example, the analytics server 102 can store the sequenced DNA in a sequence database 119 that stores the sequenced DNA in association with one or more patient identifiers established by the analytics server 102. In some embodiments, the analytics server 102 can also cause the sequence database 119 to provide the data associated with the sequenced DNA to the global patient database 110 to be stored in association with other data associated with the patient such as a workflow profile and/or limited workflow profile (also referred to as a treatment profile and/or a limited treatment profile herein) for the patient as described herein.

In some embodiments, the analytics server 102 can implement a data integration engine 104 to process data stored in the global patient database 110. For example, the analytics server 102 can implement the data integration engine 104 such that the data integration engine 104 is configured to obtain the data associated with the patients that is stored in the global patient database 110 and processes the data to be used by the data discovery engine 106. In one example, as data is obtained by the global patient database 110 for a given patient, the data can be stored in the global patient database 110 in association with one or more identifiers as part of a profile for the patient. The data integration engine 104 can then obtain the data associated with the patient (e.g., the entire profile or portions thereof) from the global patient database 110 and process the data to generate a limited treatment profile. The limited treatment profile can then be stored in the refined datasets database 108 (referred to herein as “refined datasets”) and made available to the data discovery engine 106. In this way, the analytics server 102 can maintain two separate datasets that allow for updates to the limited treatment profiles stored in the refined datasets 108 and subsequent use by the data discovery engine 106 when performing the operations described herein. As will be understood, in this example the data associated with the patient that is stored in the global patient database 110 can be updated over time such that the patient profile is represented as a set of entries associated with a time series. As the global patient database 110 is updated, the data integration engine 104 can obtain updated versions of the data associated with the patient from the global patient database 110, process the data when updating the limited treatment profiles in the refined datasets 108, and store the updates in the refined datasets 108.

In some embodiments, the analytics server 102 can implement the data discovery engine 106 that includes a model development environment 106a and a discovery engine database 106b. For example, the analytics server 102 can implement the data discovery engine 106 such that the data discovery engine 106 is configured to receive data associated with one or more limited treatment profiles that are stored in the refined datasets 108 and process the one or more limited treatment profiles. In this example, the analytics server 102 can process the one or more limited treatment profiles using the model development environment 106a. Processing the limited treatment profiles can include providing the limited treatment profiles to one or more models (e.g., machine learning-based models and/or the like) to determine one or more metrics corresponding to the performance of each of the models to indicate which model is most accurate, efficient, and/or the like at generating one or more predictions. These predictions can include indications of treatment options that have a likelihood of optimizing an outcome (e.g., lifespan) for the patients. Processing the limited treatment profiles can additionally, or alternatively, include determining one or more aspects of the limited treatment profiles. For example, where the limited treatment profiles is associated with a predetermined number of possible attributes but the patient samples 124 obtained to be processed were limited and only usable to determine a subset of the possible attributes, the model development environment 106a can process the portions of the refined patient profile that are available in the refined datasets 108 to determine one or more of the remaining attributes. In this example, data associated with the one or more remaining attributes can be stored by the data discovery engine 106 in the discovery engine database 106b. The analytics server 102 can then periodically or in real-time update the global patient database 110 based on the data associated with the limited treatment profiles (e.g., the one or more remaining attributes and/or the like) that are stored in the discovery engine database 106b.

In some embodiments, the client device 126 can include any computing device comprising a processor and non-transitory machine-readable storage capable of executing the various tasks, processes, and/or operations as described herein. The client device 126 can employ various processors such as central processing units (CPUs), graphical processing units (GPUs), and/or the like. Some non-limiting examples of such computing devices can include workstation computers, laptop computers, server computers, and/or the like. While the environment 100 includes a single client device 126, there can be multiple client devices 126. Further, the client device 126 can include any number of computing devices operating in a distributed computing environment such as, for example, a cloud computing environment. In some embodiments, the client device 126 can be associated with one or more software developers and/or one or more clinicians that are interacting with (e.g., configuring operation of) the analytics server 102 as described herein. In some embodiments, the client device 126 can be associated with one or more clinicians and/or one or more organizations involved in treating patients with the one or more diseases such as a hospital and/or the like.

In some embodiments, the analytics server 102 can generate and display an electronic platform (e.g., via the client device 126) when receiving and processing patient data associated with one or more patients, performing one or more operations when analyzing the patient data, and outputting data associated with the results of the operations performed by any of the components of the analytics server 102 such as, for example, the data discovery engine 106. The electronic platform can include graphical user interfaces (GUI) displayed by display devices of one or more client devices 126. An example of the electronic platform generated and hosted by the analytics server 102 can be a web-based application or a website configured to be displayed on different electronic devices, such as mobile devices, tablets, personal computers, and the like.

In some embodiments, treatment profiles and/or limited treatment profiles may be analyzed to identify trends, commonalities, and divergences across patients or patient subgroups. Such analysis can include direct comparison of temporal treatment sequences, cumulative dosing exposures, treatment intensities, or intervals between successive interventions. By evaluating these patterns, clinicians and researchers may discern which specific treatment pathways or regimen characteristics are consistently associated with improved or diminished outcomes, the analytics server 102 can execute one or more operations to assist with clinical decision-making. In certain cases, composite measures derived from the treatment profiles (e.g., such as dose-density indices, treatment adherence scores, or timing-of-intervention metrics) can be calculated and examined to assess their relationship to patient outcomes. The analysis may additionally include the use of statistical or machine learning algorithms to identify correlations between specific intervention sequences, dosing regimens, or therapeutic combinations and one or more clinical outcome metrics. Such analysis may involve aggregating patient-level treatment history data, mapping these histories against measured outcomes such as overall survival, event-free survival, progression-free survival, or response rates, and applying predictive modeling to determine which profile features are most strongly associated with favorable clinical endpoints. The resulting output generated by the analytics server 102, represented by the treatment profiles, can be used to generate user interfaces that can be displayed (e.g., at the client device 126) to indicate therapies to administer and/or allow for personalized treatment recommendations, optimize protocol design, or adjust ongoing therapy, thereby improving patient prognosis and enhancing resource utilization in clinical practice.

The above-mentioned components can be configured to interconnect with to each other and establish communication connections therebetween through a network (not explicitly illustrated). Examples of the network can include, but are not limited to, private or public local-area-networks (LAN), wireless LAN (WLAN) networks, metropolitan area networks (MAN), wide-area networks (WAN), and the Internet. The network can include wired and/or wireless communications according to one or more standards and/or via one or more transport mediums. The communication over the network can be performed in accordance with various communication protocols such as Transmission Control Protocol and Internet Protocol (TCP/IP), User Datagram Protocol (UDP), and IEEE communication protocols. In one example, the network can include wireless communications according to Bluetooth specification sets or another standard or proprietary wireless communication protocol. In another example, the network can also include communications over a cellular network, including, e.g., a GSM (Global System for Mobile Communications), CDMA (Code Division Multiple Access), and EDGE (Enhanced Data for Global Evolution) network.

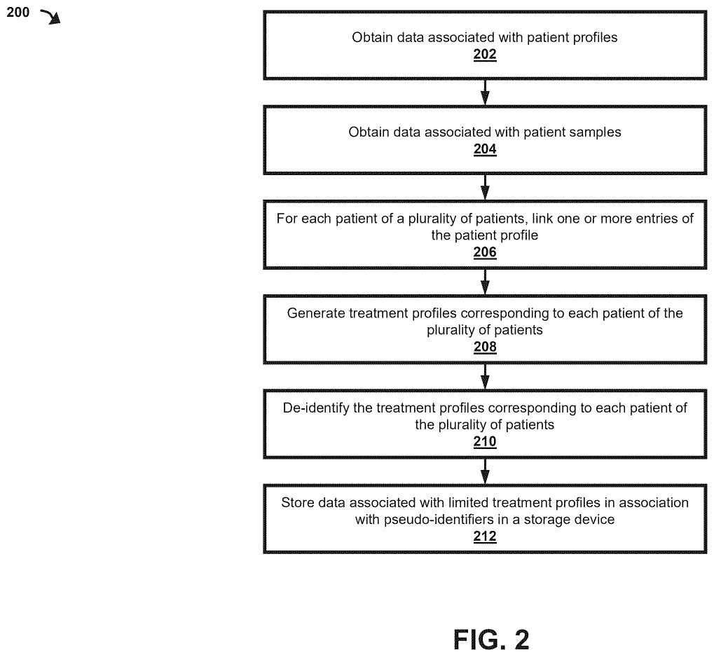

FIG. 2 is a flow diagram illustrating operations of a method 200 for managing patient data, in accordance with one or more embodiments described herein. In some implementations, one or more of the functions described with respect to the method 200 can be performed (e.g., completely, partially, and/or the like) by an analytics server that is the same as, or similar to, the analytics server 102 of FIG. 1. In some implementations, one or more of the functions described with respect to the method 200 can be performed (e.g., completely, partially, and/or the like) by another device or group of devices separate from and/or including the analytics server, such as by one or more client devices that are the same as, or similar to, the client device 126 of FIG. 1.

At operation 202, the analytics server can obtain data associated with patient profiles. For example, the analytics server can obtain the data associated with the patient profiles, where each patient profile corresponds to a patient of a plurality of patients and includes at least one entry indexed with time stamps in accordance with a period of time. As an example, where the plurality of patients is being treated for AML, the analytics server can obtain the data associated with the patient profiles of the patients based on the patients interacting with their clinician. In this example, the clinician(s) can generate information about the patient (e.g., indicating the progression of the disease as it affects the patient, the symptoms being experienced by the patient, and/or the like) and provide the information as input to a client device in communication with the analytics server. The client device can then generate the data associated with the patient profiles and provide (e.g., transmit) the data associated with the patient profiles to the analytics server.

In some embodiments, the analytics server can update a global patient database (e.g., that is the same as, or similar to, the global patient database 110 of FIG. 1) based on the analytics server obtaining the data associated with the patient profiles. For example, for a new patient, the analytics server can generate a new entry in the global patient database representing at least a portion of a profile for the patient. The analytics server can then update the entry in the global patient database based on the data associated with the patient profile for the new patient. As further data associated with the patient profile is received (e.g., on subsequent visits by the patient to the clinician and/or upon subsequent review of the patient profile by the clinician), the analytics server can update (e.g., add) entries to the patient profile for the patient.

In some embodiments, the analytics server can associate each entry of each patient profile with a time stamp indicating the point in time at which the entry was generated and/or received by the analytics server. For example, the analytics server can associate each entry of each patient profile with a time stamp indicating the point in time at which the client device (operated by the clinician) received the input used by the client device to generate the entry. In another example, the analytics server can associate each entry of each patient profile with a time stamp generated by the analytics server in response to receiving the data associated with the patient profile from the client device. In this way, the analytics server can maintain the global patient database such that all of the data received by the analytics server for a given patient is stored in association with the time it was received, thereby developing a set of entries over a period of time representing the state of the patient at points in time at which the states representing the patient are observed. In some embodiments, one or more entries can be cross-indexed with information associated with the patient. For example, in response to receiving and processing data associated with the patients such as results from one or more tests and/or the like, the analytics server can determine an age for the patient at the point at which the test was performed and include the age with the respective entries. The analytics server can then update the age for the patient at the point at which the test was performed when generating the entries for a limited treatment profile corresponding to the patient as described herein. In some embodiments, each entry corresponding to each patient in the global patient database can include data representing one or more of: patient demographics; a date of diagnosis for a disease; a subtype of the disease; blood test results; bone marrow biopsy results; cytogenic analysis results; molecular analysis results; treatment administration; or patient responses to treatment administration, and/or the like.

In some embodiments, the analytics server can receive and/or generate data associated with a profile for each patient and store the data associated with the profile in the global patient database. For example, the analytics server can receive input from a clinician indicating one or more aspects regarding treatment of a patient having AML. In this example, the input can represent one or more treatments to be provided to the patient as specified by a profile for the patient, one or more adjustments to the one or more profiles based on responses by the patient to certain therapies, and/or the like. In some embodiments, the analytics server can update the profile based on outputs generated by the data discovery engine and/or one or more models developed by the data discovery engine. For example, the analytics server can provide a limited treatment profile associated with a patient to the data discovery engine to cause the data discovery engine to generate an output. In this example, the analytics server can then update the profile as represented in the global patient database based on the output of the data discovery engine. The analytics server can then cause the data integration engine to update the limited treatment profile based on the updated profile stored in the global patient database.

At operation 204, the analytics server can obtain data associated with patient samples. For example, the analytics server can obtain the data associated with the patient samples from a laboratory system (e.g., a laboratory system that is the same as, or similar to, the laboratory system 112 of FIG. 1) and/or a sequencing system (e.g., a sequencing system that is the same as, or similar to, the sequencing system 118 of FIG. 1). In an example, the analytics server can obtain the data associated with the patient samples based on (e.g., in accordance with) one or more profiles of the patient profiles stored in the global patient database of the analytics server. In some embodiments, for each patient having a treatment profile stored in the global patient database, the analytics server can obtain data associated with one or more flow cytometry results. For example, as can be specified by profiles of patients, one or more patient samples can be collected from one or more patients and provided to a laboratory operating the laboratory system. The one or more patient samples can then be processed by a sample processing system (e.g., a sample processing system that is the same as, or similar to, the sample processing system 114 of FIG. 1) to generate results (illustrated as flow+PCR 116 of FIG. 1).

In an example, the samples can be processed by a flow cytometer associated with the sample processing system. The flow cytometer can interrogate single cells in a fluid stream. By measuring light scatter and fluorescence from specific dyes or antibodies, the flow cytometer can characterize the physical and chemical properties of each cell at high speed, enabling clinicians and/or researchers to identify cell types, assess viability, and analyze cellular processes at a single-cell level. In another example, the samples can be processed by a PCR machine, such as a droplet digital PCR machine (ddPCR). The ddPCR machine can precisely partition a sample into thousands of microscopic droplets. Each droplet can act as an individual reaction chamber, and the machine can then amplify target DNA within each droplet using PCR. By detecting fluorescence from positive droplets (containing amplified DNA) and negative ones (lacking amplification), a ddPCR machine can directly counts target molecules for absolute quantification, offering high sensitivity and precision for rare target detection.

In another example, the samples processed by the laboratory system can be provided to the sequencing system to cause the sequencing system to sequence the DNA of the patient. For example, the samples processed by the laboratory system can undergo library preparation, where the samples are fragmented into short, uniform pieces. These fragments can then be equipped with adapters that facilitate attachment to a flow cell surface. Within the sequencing system, millions of these fragments can be shotgun sequenced in parallel. Each fragment undergoes a series of cycles where specific fluorescently labeled nucleotides are incorporated, allowing for real-time identification of the added base. By analyzing the vast collection of short sequence reads, the sequencing system can then assemble the fragments and reconstruct the complete DNA sequence (or target regions thereof). The sequencing system can then transmit the data associated with the complete DNA sequence or targets of the DNA sequence to the analytics server and stored in the sequence database as described herein.

At operation 206, the analytics server can, for each patient of a plurality of patients, link one or more entries of the patient profile with the corresponding data associated with the patient samples and/or the DNA sequence for that patient. For example, the analytics server can link a patient profile corresponding to the patient with the data associated with the patient samples corresponding to the patient by entering the data associated with the patient samples as an entry in the patient profile. The analytics server can also update the links periodically or continuously as additional data is received. For example, as clinicians provide updated inputs to client devices (e.g., representing observations between patient treatments, updates to a profile of a patient, and/or the like), updated patient data can be obtained by the analytics server. In this example, the analytics server can generate one or more entries in the patient profile including the updated patient data. This process can similarly be performed as data associated with patient samples is processed.

In some embodiments, the entries can be further associated with a given period of time. For example, the analytics server can determine a point in time for each entry and associate the entry with the point in time. In this example, the analytics server can include a time stamp indicating the time the data was generated (e.g., by the client device operated by the clinician, the laboratory system, and/or the sequencing system) with each entry. Additionally, or alternatively, the analytics server can include a time stamp indicating the time the data was received by the analytics server. In this way, the analytics server can store the data received from the client device, the laboratory system, and/or the sequencing system as a time series of events that can be used when performing one or more operations as described herein.

At operation 208, the analytics server can generate treatment profiles corresponding to each patient of the plurality of patients. For example, the analytics server can generate treatment profiles that correspond to each patient based on the analytics server linking the one or more entries of the patient profile with the data associated with the patient samples. In this example, the analytics server can then store the treatment profile in association with the patient profile and the data associated with the samples of the patient.

In some embodiments, the analytics server can include at least one patient identifier in the treatment profile. For example, the analytics server can include at least one direct identifier that directly links the treatment profile for the patient with the identity of the patient. Examples can include a patient's name, address, government-issued identifier, combinations thereof, and/or the like. Additionally, or alternatively, the analytics server can include at least one indirect identifier that links the treatment profile to an aspect of the identity of the patient. For example, the analytics server can include a partial name of the patient, a date or set of dates on which the patient receives treatments, an account number for an account associated with the patient, a telephone number, an email address, a location identifier (e.g., a city, state, zip code, and/or the like associated with the patient), a medical record number, a health plan beneficiary number, a device identifier, a biometric identifier, combinations thereof, and/or the like.

In some embodiments, the analytics server can include at least one pseudo-identifier corresponding to the patient in the treatment profile and/or the limited treatment profile. For example, the analytics server can associate the at least one patient identifier with a pseudo-identifier that is unique to the global patient dataset and/or the refined datasets. In another example, the data integration engine can include the at least one pseudo-identifier corresponding to the patient in the treatment profile when generating and/or updating a limited treatment profile for the patient. The pseudo-identifier included in the limited treatment profile can then be provided to the data discovery engine along with the limited treatment profile to cause the data discovery engine to perform one or more operations and output data in association with the pseudo-identifier. In these examples, the at least one pseudo-identifier can include a randomized alphanumeric code, a hash value generated based on the analytics server hashing one or more of the direct identifier and/or the indirect identifier, and/or the like.

In some embodiments, the analytics server can transform one or more of the entries included in treatment profiles when generating and/or updating entries in a corresponding limited treatment profile. For example, the analytics server can cause the treatment profile for one or more patients stored in the global patient database to be provided to the data integration engine. In this example, the data integration engine can then transform the one or more of the entries of the treatment profile based on one or more criteria and store data associated with the transformed entries in the corresponding limited treatment profile. Examples of transformations can include adjusting one or more values of the entries in the treatment profile to normalize a total number of cells measured for a given sample, a volume associated with a given sample type collected and analyzed, values representing variations in RNA present in a sample, and/or the like. Additional or alternative examples of transformations can include subtraction of background fluorescence and/or other background noise present in the data associated with the patient or the data associated with the sample of the patient.

In some embodiments, the analytics server can transform the one or more entries included in the treatment profiles when generating and/or updating entries in a corresponding limited treatment profile to allow for compatibility with one or more models of a model development environment. For example, the analytics server can transform the one or more entries such that the values represented by the treatment profiles are compatible with the feature values each model included in the model development engine is configured to receive. Additionally, or alternatively, the analytics server can add and/or remove one or more values when generating and/or updating entries in the corresponding limited treatment profile. For example, where one or more values are not available for a given patient, the analytics server can include a default value that indicates the value is not available to enable the operation of the models in the model development environment.

At operation 210, the analytics server can de-identify the treatment profiles corresponding to each patient of the plurality of patients. For example, the analytics server can de-identify the treatment profiles corresponding to each patient of the plurality of patients based on the generation of the limited treatment profiles. In this example, for each treatment profile associated with a patient, the analytics server can cause the data integration engine to generate a limited treatment profile that corresponds to the treatment profile, where the identity of the patient is not determinable by remote devices (e.g., devices other than the analytics server) from the limited treatment profile. In some embodiments, the analytics server can cause the data integration engine to generate the limited treatment profiles based on generation of a pseudo-identifier. For example, the analytics server can cause the data integration engine to generate a pseudo-identifier in response to receiving a treatment profile for a patient that does not have a corresponding limited treatment profile. In this example, the data integration engine can maintain a mapping of patient identifiers to pseudo-identifiers such that the data integration engine can determine correlations between the treatment profiles and the limited treatment profiles as the limited treatment profiles are initialized.

In some embodiments, the analytics server can de-identify the treatment profiles corresponding to each patient of the plurality of patients based on the analytics server causing one or more operations to be performed to update the data included in the treatment profiles. For example, the analytics server can cause the data integration engine to obtain the data associated with the treatment profiles from the global patient database and determine an update to the period of time during which the entries in the treatment profile were received and/or generated. In this example, the analytics server can generate the limited treatment profiles based on the entries in the treatment profile and the update to the period of time. For instance, where the update to the period of time includes an offset of three months, the analytics server can generate the limited treatment profile by updating time stamps (sometimes referred to as second time stamps) associated with each entry using (e.g., adding or subtracting) an offset value representing three months prior to the date associated with each entry in the global patient database. As additional entries are added to the treatment profile for the patient, the analytics server can cause the data associated with each new entry to be similarly offset by the data integration engine when updating the corresponding limited treatment profile. In some embodiments, the analytics server can also maintain a mapping of offsets with patient identifiers and/or pseudo-identifiers such that the data integration engine can update the entries when generating and/or updating the limited treatment profiles based on the offset assigned to each treatment profile and/or each limited treatment profile. It will be understood that the analytics server can associate deterministic or random offsets for each treatment profile and/or limited treatment profile to further obfuscate the identity of the patient for a given treatment profile or limited treatment profile.

At operation 212, the analytics server can store data associated with limited treatment profiles in association with pseudo-identifiers in a storage device. For example, the analytics server can store the data associated with the limited treatment profile in the refined datasets database. In other examples, the analytics server can store the data associated with the limited treatment profile in another database (e.g., associated with a device such as a client device, another analytics server, and/or the like). In these examples, the analytics server can store the data associated with the limited treatment profile such that the data is accessible by the data discovery engine implemented by the server or by another device in communication with the database.

As described herein, the data discovery engine can generate data based on the execution of one or more operations by the data discovery engine. This data can include, for example, data associated with one or more treatments to be provided to a patient, data indicating that one or more markers are correlated with a given disease (e.g., generally or at a given stage of progression for the disease), and/or the like. In some examples, where the data generated by the data discovery engine represents one or more entries to be added to and/or updated in a treatment profile for a patient, the analytics server can cause the data representing the one or more entries to be provided to the global patient database. The analytics server can then cause the global patient database to update (e.g., add and/or the like) the data representing the one or more entries to the corresponding treatment profile for the patient. For example, the analytics server can determine a correlation between the pseudo-identifier included with the data output by the data discovery engine and the patient identifiers associated with the treatment profiles stored in the global patient database and, where the pseudo-identifier matches a given patient identifier included in a treatment profile, the analytics server can add the data output by the data discovery engine to the corresponding treatment profile.

In some embodiments, the analytics server can cause the data integration engine to update the limited treatment profiles stored in the refined datasets based on one or more operations performed by the data discovery engine. For example, the data discovery engine can generate data associated with one or more treatment profiles based on execution of a model by the data discovery engine. In this example, the analytics server can cause one or more treatment profiles stored in the global patient database to be updated in response to the execution of the model. The analytics server can then cause the data integration engine to obtain the updated entries from the global patient database and update the corresponding entries in limited treatment profiles stored in the refined datasets. In this way, the analytics server can periodically or continuously update the limited treatment profiles.

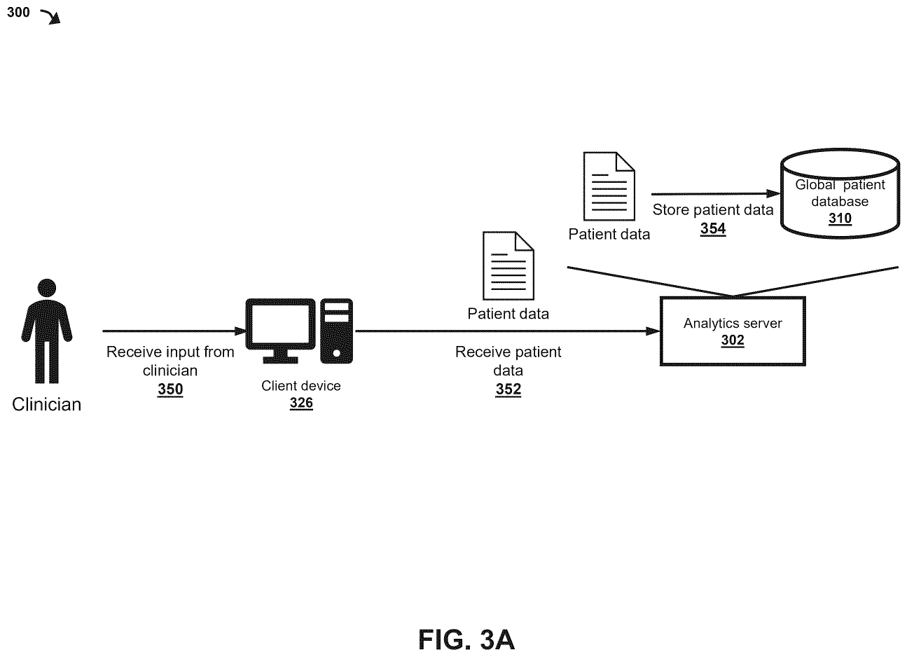

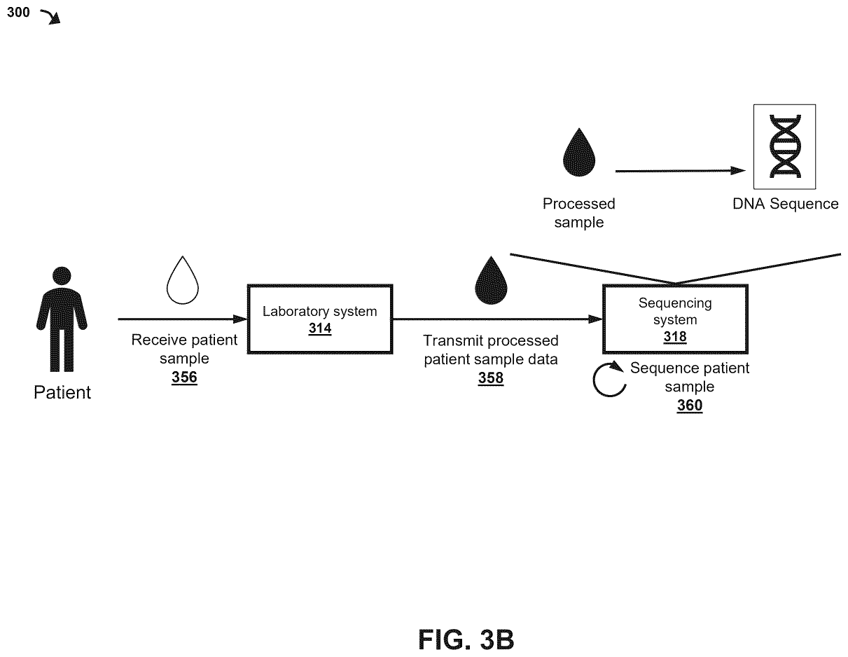

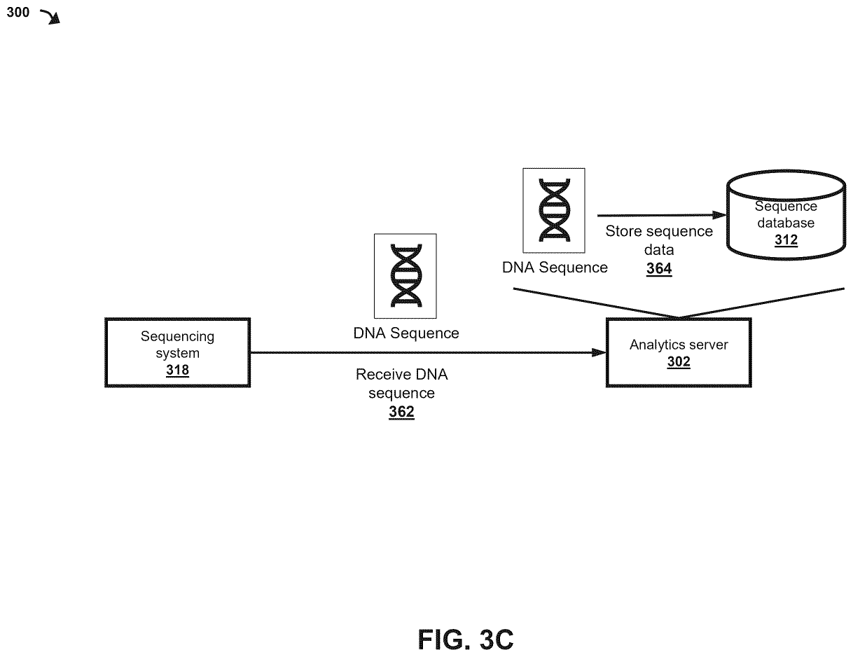

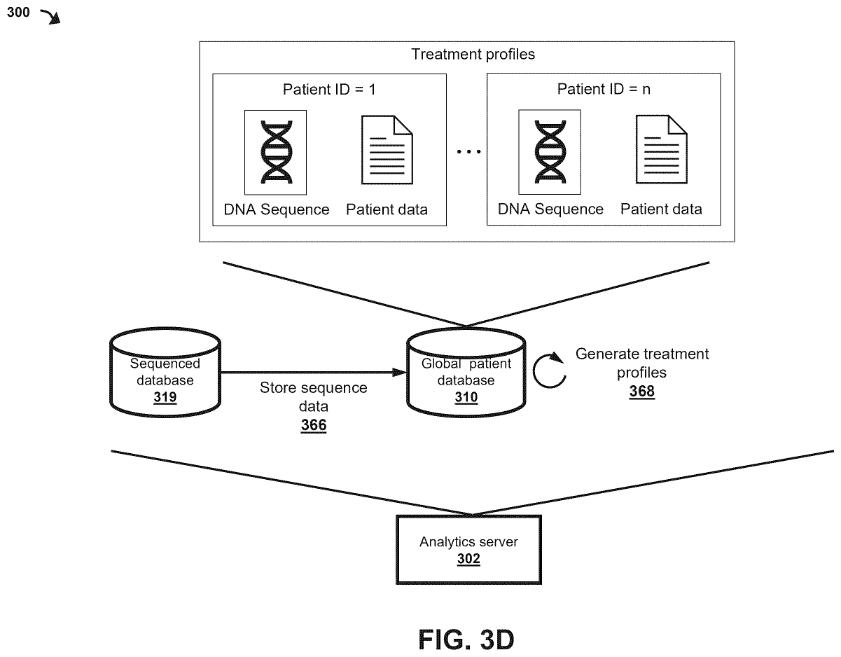

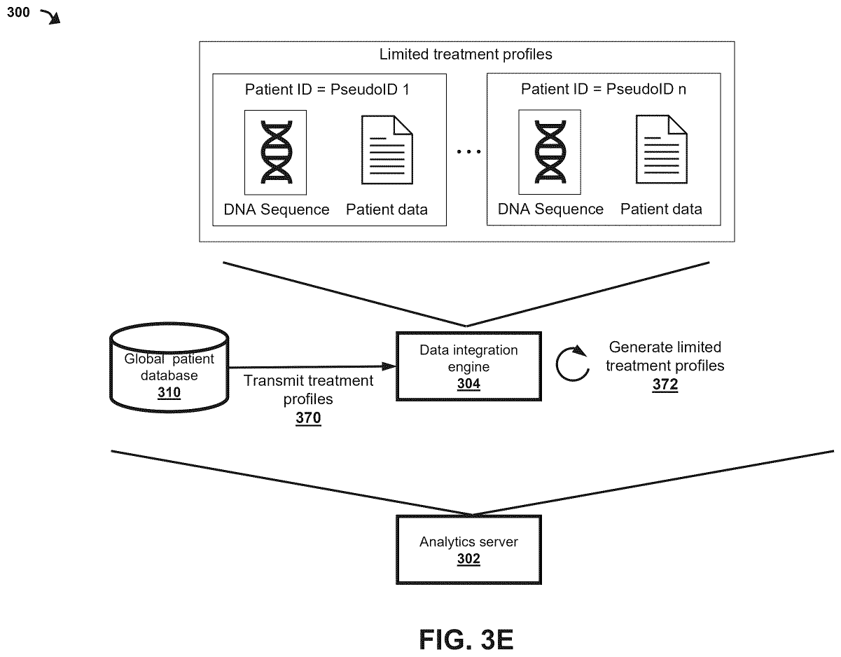

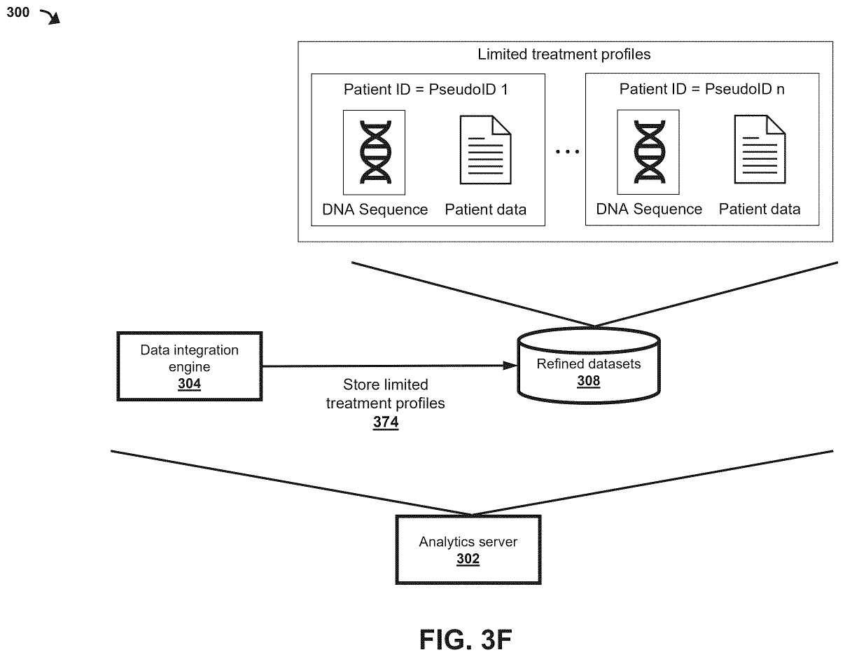

FIG. 3A-3F are a diagram of an example implementation 300 of the method of FIG. 2, in accordance with one or more embodiments described herein. In some embodiments, the operations of the implementation 300 can be implemented by an analytics server 302, a global patient database 310, a laboratory system 314, and a sequencing system 318 that are the same as, or similar to, the analytics server 102, the global patient database 110, the laboratory system 112, and the sequencing system 118 of FIG. 1. Additionally, or alternatively, one or more of the operations of the implementation 300 can involve a data integration engine 304, a global patient database 310 and/or a sequence database 319 that are the same as, or similar to, the data integration engine 104, a global patient database 110 and/or a sequence database 119 of FIG. 1.

At operation 350, input can be received by a client device 326 from a clinician. For example, as the clinician meets with a patient, the clinician can provide input to the client device 326 indicating observations associated with the state of the patient and/or to configure a profile for the patient. This input can be provided at a first visit between the patient and the clinician and/or at one or more subsequent visits between the patient and the clinician.

At operation 352, patient data can be received by an analytics server 302. For example, the patient data can be received by the analytics server 302 based on (e.g., in response to) the input being provided by the clinician to the client device 326. The patient data can be associated with the input provided by the clinician and can specify one or more aspects of a patient profile and/or one or more aspects of a profile associated with the patient.

At operation 354, the analytics server 302 can store the patient data in the global patient database 310. For example, the analytics server 302 can store the patient data in the global database initially (e.g., when creating a treatment profile for the patient. Additionally, or alternatively, the analytics server 302 can store the patient data in the global patient database 310 in response to inputs received on one or more subsequent visits between the patient and the clinician and/or upon review of the treatment profile for the patient by the clinician.

At operation 356, the patient can provide a sample as described herein (e.g., blood, tissue, and/or the like) to a laboratory system 314. The laboratory system 314 can then process the sample prior to the sample being sequenced. For example, the laboratory system 314 can process the sample using a flow cytometer, a ddPCR and/or the like. At operation 358, the laboratory system 314 can then provide the processed sample and/or the data associated with the results of the sample processing to the sequencing system 318.

At operation 360, the sequencing system 318 can sequence the processed sample. For example, the sequencing system 318 can sequence the processed sample to identify a complete DNA sequence and/or target sequences of the DNA sequence. At operation 362 the analytics server 302 can then receive the data associated with the DNA sequence (or target sequence(s)) from the sequencing system 318. At operation 364, the analytics server 302 can store the DNA sequence in the sequence database 319.

At operation 366, the analytics server 302 can cause the data associated with the DNA sequence to be stored in the global patient database 310 in association with the patient data. For example, at operation 368, the analytics server 302 can generate a treatment profile for the patient including a patient identifier and include the patient data and the data associated with the DNA sequence as entries in the treatment profile. The analytics server 302 can also associate the entries with a time stamp indicating a time at which the data included in each entry was generated and/or received. Additionally, or alternatively, at operation 366, the analytics server 302 can cause the global patient database 310 to include the data associated with the DNA sequence included in the sequenced database 312 to be included in a treatment profile corresponding to the patient that provided the sample.

At operation 370, the analytics server 302 can cause data associated with the treatment profiles to be provided to the data integration engine 304. For example, as treatment profiles are created and/or updated, the analytics server 302 can cause data associated with the treatment profiles to be provided to the data integration engine 304.

At operation 372, the analytics server 302 can cause the data integration engine 304 to generate limited treatment profiles corresponding to each treatment profile. For example, the analytics server 302 can cause the data integration engine 304 to generate limited treatment profiles corresponding to each treatment profile, such that the limited treatment profiles include a patient identifier that is a pseudo-identifier (illustrated as PseudoID 1-PseudoID n). Additionally, or alternatively, the analytics server 302 can cause the data integration engine 304 to generate limited treatment profiles corresponding to each treatment profile, where the entries included in the limited treatment profile are associated with second time stamps that are offset from the first time stamps included with each entry in the treatment profiles. In this way, the analytics server 302 can curate a refined dataset 308 that includes limited treatment profiles that, in part, include patient data that can be used in research settings without the need for further abstraction (e.g., to comply with one or more laws, regulations, and/or the like).

At operation 374, the analytics server 302 can cause the data integration engine 304 to store the limited treatment profiles in the refined datasets database 308. For example, the analytics server 302 can cause the data integration engine 304 to store the limited treatment profiles in the refined datasets database 308, such that the limited treatment profiles are made available to other systems or processing engines implemented by the analytics server 302 or to systems or processing engines implemented by remote devices (e.g., client devices operated by other research organizations and/or the like). In this example, the other systems or processing engines can be the same as, or similar to, the data discovery engine 106 of FIG. 1.

The various illustrative logical blocks, modules, circuits, and algorithm steps described in connection with the embodiments disclosed herein can be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans can implement the described functionality in varying ways for each particular application, but such implementation decisions should not be interpreted as causing a departure from the scope of this disclosure or the claims.

Embodiments implemented in computer software can be implemented in software, firmware, middleware, microcode, hardware description languages, or any combination thereof. A code segment or machine-executable instructions can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc., can be passed, forwarded, or transmitted via any suitable means, including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the functions can be stored as one or more instructions or code on a non-transitory computer-readable or processor-readable storage medium. The steps of a method or algorithm disclosed herein can be embodied in a processor-executable software module, which can reside on a computer-readable or processor-readable storage medium. A non-transitory computer-readable or processor-readable media includes both computer storage media and tangible storage media that facilitate the transfer of a computer program from one place to another. A non-transitory processor-readable storage media can be any available media that can be accessed by a computer. By way of example, and not limitation, such non-transitory processor-readable media can comprise RAM, ROM, EEPROM, CD-ROM or other optical disk storage, magnetic disk storage or other magnetic storage devices, or any other tangible storage medium that can be used to store desired program code in the form of instructions or data structures and that can be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm can reside as one or any combination or set of codes and/or instructions on a non-transitory processor-readable medium and/or computer-readable medium, which can be incorporated into a computer program product.

The preceding description of the disclosed embodiments is provided to enable any person skilled in the art to make or use the embodiments described herein and variations thereof. Various modifications to these embodiments will be readily apparent to those skilled in the art, and the principles defined herein can be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A system for processing input data comprising a plurality of elements to transform the input data used to generate a profile into a protected dataset for secured processing, the system comprising:
one or more processors configured to:
obtain data associated with individual profiles, each individual profile corresponding to an individual of a plurality of individuals and comprising at least one entry indexed in accordance with a period of time;
obtain data associated with individual samples collected based on profiles associated with each individual of the plurality of individuals and indexed in accordance with the period of time;
for each individual of the plurality of individuals, link one or more entries of the individual profile corresponding to the individual with individual samples corresponding to the individual based on the period of time and the profile for each individual;
generate workflow profiles corresponding to each individual of the plurality of individuals based on linking the one or more entries of the individual profile with individual samples, each workflow profile comprising an individual identifier;
de-identify the workflow profiles corresponding to each individual of the plurality of individuals to generate limited workflow profiles, each limited treatment comprising a pseudo-identifier linked to the individual identifier; and
store data associated with the limited workflow profiles in association with the pseudo-identifier in a storage device, the storage device allowing access to the data associated with the limited workflow profiles by one or more remote devices.

2. The system of claim 1, wherein the one or more processors configured to obtain the data associated with the individual profiles are configured to:
obtain the data associated with the individual profiles where each entry of the at least one entry comprises a time stamp based on the period of time and represents one or more of: individual attributes; a date of diagnosis for a condition; a subtype of the condition; blood test results; bone marrow biopsy results; cytogenic analysis results; molecular analysis results; treatment administration; or individual responses to treatment administration.

3. The system of claim 1, wherein the one or more processors configured to obtain the data associated with the individual samples are to:
for each individual of the plurality of individuals:
obtain data associated with flow cytometry results generated based on a sample collected from the individual; or
obtain data associated with droplet digital polymerase chain reaction (ddPCR) results generated based on a sample collected from the individual.

4. The system of claim 1, wherein the one or more processors configured to generate the workflow profiles corresponding to each individual of the plurality of individuals are configured to:
transform one or more entries of the workflow profiles to normalize the one or more entries.

5. The system of claim 4, wherein the one or more processors configured to transform the one or more entries are configured to:
transform the one or more entries based on one or more features associated with one or more models executed by the one or more remote devices.

6. The system of claim 1, wherein the one or more processors are further configured to:
for one or more individuals:
obtain data associated with model outputs from the one or more remote devices, the model outputs comprising data associated with an update to one or more entries of the limited workflow profile of the individual; and
in response to obtaining the data associated with the model outputs:
update the workflow profile of the individual to include the data associated with the update to the one or more entries of the limited workflow profile of the individual, or
update the limited workflow profile of the individual to include the data associated with the update to the one or more entries of the limited workflow profile of the individual.

7. The system of claim 1, wherein the one or more processors are further configured to:
for one or more individuals:
obtain data associated with model outputs from the one or more remote devices, the model outputs comprising data associated with a new entry to the one or more entries of the limited workflow profile of the individual; and
in response to obtaining the data associated with the model outputs:
add the data associated with the new entry to the one or more entries of the workflow profile of the individual, or
add the data associated with the new entry to the one or more entries of the limited workflow profile of the individual.

8. The system of claim 1, wherein the one or more processors configured to de-identify the workflow profiles to generate limited workflow profiles are configured to:
determine an updated period of time based on the period of time and an offset value; and
for each individual of the plurality of individuals:
update a time stamp for each entry of the workflow profiles based on the updated period of time such that each time stamp is matched with a second time stamp, the second time stamp offset from the time stamp by the offset value.

9. A method for processing input data comprising a plurality of elements to transform the input data into a protected dataset for secured processing comprising:
obtaining, by at least one processor, data associated with individual profiles, each individual profile corresponding to an individual of a plurality of individuals and comprising at least one entry indexed in accordance with a period of time;
obtaining, by the at least one processor, data associated with individual samples collected based on profiles associated with each individual of the plurality of individuals and indexed in accordance with the period of time;
for each individual of the plurality of individuals, linking, by the at least one processor, one or more entries of the individual profile corresponding to the individual with individual samples corresponding to the individual based on the period of time and the profile for each individual;
generating, by the at least one processor, workflow profiles corresponding to each individual of the plurality of individuals based on linking the one or more entries of the individual profile with individual samples, each workflow profile comprising an individual identifier;
de-identifying, by the at least one processor, the workflow profiles corresponding to each individual of the plurality of individuals to generate limited workflow profiles, each limited treatment comprising a pseudo-identifier linked to the individual identifier; and
storing, by the at least one processor, data associated with the limited workflow profiles in association with the pseudo-identifier in a storage device, the storage device allowing access to the data associated with the limited workflow profiles by one or more remote devices.

10. The method of claim 9, wherein obtaining the data associated with the individual profiles comprises:
obtaining, by the at least one processor, the data associated with the individual profiles where each entry of the at least one entry comprises a time stamp based on the period of time and represents one or more of: individual attributes; a date of diagnosis for a condition; a subtype of the condition; blood test results; bone marrow biopsy results; cytogenic analysis results; molecular analysis results; treatment administration; or individual responses to treatment administration.

11. The method of claim 9, wherein obtaining the data associated with the individual samples comprises:
for each individual of the plurality of individuals:
obtaining, by the at least one processor, data associated with flow cytometry results generated based on a sample collected from the individual; or
obtaining, by the at least one processor, data associated with droplet digital polymerase chain reaction (ddPCR) results generated based on a sample collected from the individual.

12. The method of claim 9, wherein generating the workflow profiles corresponding to each individual of the plurality of individuals comprises:
transforming, by the at least one processor, one or more entries of the workflow profiles to normalize the one or more entries.

13. The method of claim 12, wherein transforming the one or more entries comprises:
transforming, by the at least one processor, the one or more entries based on one or more features associated with one or more models executed by the one or more remote devices.

14. The method of claim 9, wherein the method further comprises:
for one or more individuals:
obtaining, by the at least one processor, data associated with model outputs from the one or more remote devices, the model outputs comprising data associated with an update to one or more entries of the limited workflow profile of the individual; and
in response to obtaining the data associated with the model outputs:
updating, by the at least one processor, the workflow profile of the individual to include the data associated with the update to the one or more entries of the limited workflow profile of the individual, or
updating, by the at least one processor, the limited workflow profile of the individual to include the data associated with the update to the one or more entries of the limited workflow profile of the individual.

15. The method of claim 9, wherein the method further comprises:
for one or more individuals:
obtaining, by the at least one processor, data associated with model outputs from the one or more remote devices, the model outputs comprising data associated with a new entry to the one or more entries of the limited workflow profile of the individual; and
in response to obtaining the data associated with the model outputs:
adding, by the at least one processor, the data associated with the new entry to the one or more entries of the workflow profile of the individual, or
adding, by the at least one processor, the data associated with the new entry to the one or more entries of the limited workflow profile of the individual.

16. The method of claim 9, wherein de-identifying the workflow profiles to generate limited workflow profiles comprises:
determining, by the at least one processor, an updated period of time based on the period of time and an offset value; and
for each individual of the plurality of individuals:
updating, by the at least one processor, a time stamp for each entry of the workflow profiles based on the updated period of time such that each time stamp is matched with a second time stamp, the second time stamp offset from the time stamp by the offset value.

17. A non-transitory, computer-readable medium having instructions stored thereon that, when executed by one or more processors, cause the one or more processors to:
obtain data associated with individual profiles, each individual profile corresponding to an individual of a plurality of individuals and comprising at least one entry indexed in accordance with a period of time;
obtain data associated with individual samples collected based on profiles associated with each individual of the plurality of individuals and indexed in accordance with the period of time;
for each individual of the plurality of individuals, link one or more entries of the individual profile corresponding to the individual with individual samples corresponding to the individual based on the period of time and the profile for each individual;
generate workflow profiles corresponding to each individual of the plurality of individuals based on linking the one or more entries of the individual profile with individual samples, each workflow profile comprising an individual identifier;
de-identify the workflow profiles corresponding to each individual of the plurality of individuals to generate limited workflow profiles, each limited treatment comprising a pseudo-identifier linked to the individual identifier; and
store data associated with the limited workflow profiles in association with the pseudo-identifier in a storage device, the storage device allowing access to the data associated with the limited workflow profiles by one or more remote devices.

18. The non-transitory, computer-readable medium of claim 17, wherein the instructions that cause the one or more processors to obtain the data associated with the individual profiles cause the one or more processors to:
obtain the data associated with the individual profiles where each entry of the at least one entry comprises a time stamp based on the period of time and represents one or more of: individual attributes; a date of diagnosis for a condition; a subtype of the condition; blood test results; bone marrow biopsy results; cytogenic analysis results; molecular analysis results; treatment administration; or individual responses to treatment administration.

19. The non-transitory, computer-readable medium of claim 17, wherein the instructions that cause the one or more processors to obtain the data associated with the individual samples cause the one or more processors to:
for each individual of the plurality of individuals:
obtain data associated with flow cytometry results generated based on a sample collected from the individual; or
obtain data associated with droplet digital polymerase chain reaction (ddPCR) results generated based on a sample collected from the individual.

20. The non-transitory, computer-readable medium of claim 17, wherein the instructions that cause the one or more processors to generate the workflow profiles corresponding to each individual of the plurality of individuals cause the one or more processors to:
transform one or more entries of the workflow profiles to normalize the one or more entries.
